(19) United States
(12) Patent Application Publication
(10) Pub. No.: US 2004/0176155 A1
(43) Pub. Date: Sep. 9, 2004

(54) Poker-type game and method

(76) Inventors: Steven T. Gold, Las Vegas, NV (US); Jeremy Zarowitz, Las Vegas, NV (US)

Correspondence Address: WEISS & MOY PC, 4204 NORTH BROWN AVENUE, SCOTTSDALE, AZ, 85251, US

(21) Appl. No.: 10/382,738

(22) Filed: Mar. 7, 2003

(51) Int. Cl. A63F 13/00

(52) U.S. Cl. 463/13

(57) ABSTRACT

A video poker-style game and method in which a player is provided the option of placing wagers on certain selected winning hands. In one embodiment, a player is provided the option of placing at least one wager on obtaining at least one selected winning hand before play begins. In another embodiment, a player is provided the option of placing at least one wager on obtaining at least one selected winning hand before play begins and not provided the option of discarding and drawing replacement cards. In still another embodiment, a player is provided the option of placing at least one wager on obtaining at least one selected winning hand after the initial hand is dealt. In yet another embodiment, a player is provided the option of placing at least one wager on obtaining at least one selected winning hand after the initial hand is dealt and after the player has selected which cards to discard or to hold. In a further embodiment, a player is provided the option of placing at least one wager on obtaining at least one selected winning hand before play begins and is provided a similar option after the initial hand is dealt. In a still further embodiment, a player is provided the option of placing at least one wager on obtaining at least one selected winning hand before play begins and is provided a similar option after the initial hand is dealt and after the player has selected which cards to discard or to hold. The jackpot payable for achievement of a winning hand that has been wagered upon can be determined from a fixed payout table or from a progressive payout table.

### FIELD OF THE INVENTION

This invention relates generally to poker-style games and methods, and more particularly to poker-style games and methods that provide opportunities for a player to make wagers on certain selected winning hands which can provide significant payouts and thus increase player excitement.

### BACKGROUND OF THE INVENTION

The game of poker is widely played at peoples' homes and in a casino setting. At a casino, it is played both in a traditional format, with traditional playing cards, and in an electronic format. In the electronic version, typically known as “video poker”, a player makes a wager, pushes a button to start the game, and is then presented with five cards shown on the video display. A player can choose to either keep the cards or discard a specified number of cards and receive replacement cards. Whether or not the player's final hand qualifies for a payment is determined according to a pay table, which is generally displayed on the video poker machine itself.

The best hand that a player can achieve in classic five card poker of the type typically played on video poker machines is a royal flush. A royal flush consists of an Ace-high straight, where all of the cards have the same suit.

However, many video poker players find that the basic game has become somewhat stale and boring. In addition, many feel that the payouts associated with video poker are not high enough to make the game exciting. For instance, the chances of a player achieving a royal flush are generally about 1 in 35,000. However, since the player essentially wagers on all potential winning hands at once, the payout for a royal flush is typically no more than 800 credits or coins to every one credit or coin wagered. If the player were provided the opportunity to wager on any one selected hand (out of a large number of possible hands), in some instances, a player could stand to win at least one hundred times what the player would normally win by wagering in the typical manner and achieving the same winning hand.

A need therefore existed for providing a video poker-style game and method that permits additional wagering opportunities by allowing each player to wager on certain selected winning hands to significantly increase potential payouts, player excitement and amounts wagered.

### SUMMARY OF THE INVENTION

It is an object of the present invention to provide a poker-style game and method that provides a player with an opportunity to place wagers on obtaining at least one certain selected winning hand.

It is a further object of the present invention to provide a poker-style game and method that provides a progressive jackpot feature for jackpots associated with wagering on obtaining at least one certain selected winning hand.

Other objects, features and advantages of the present invention will become apparent from a consideration of the following detailed description.

### BRIEF DESCRIPTION OF THE PREFERRED EMBODIMENTS

In accordance with one embodiment of the present invention, a video poker-style game is disclosed. The game comprises, in combination: a video display adapted to display to a player a poker-style game; and means for permitting the player to make at least one wager to obtain on the video display at least one certain selected winning hand.

In accordance with another embodiment of the present invention, a video poker-style game is disclosed. The game comprises, in combination: means for displaying a payout table associated with probabilities of obtaining at least one selected winning hand of the game; means for permitting the player to make the at least one wager on obtaining at least one selected winning hand of the game; means for displaying the payout associated with each the at least one wager; means for displaying an initial hand of playing cards for the video poker-style game; means for permitting the player to hold a desired number of the cards from the initial hand; means for permitting the player to receive a replacement card for each of the cards that the player elects not to hold; means for determining if a winning hand has been achieved in the game; and means for paying the player in accordance with the payout table in the event that a winning hand is achieved and the player had made the at least one wager on the specific winning hand that was achieved.

In accordance with another embodiment of the present invention, a video poker-style game is disclosed. The game comprises, in combination: means for displaying a payout table associated with probabilities of obtaining at least one selected winning hand of the game; means for providing the player with an option to make the at least one wager on obtaining a certain selected winning hand of the game; means for displaying the payouts associated with each the at least one wager; means for displaying a hand of playing cards for the video poker-style game; means for determining if a winning hand has been achieved in the game; and means for paying the player in accordance with the payout table in the event that a winning hand is achieved and the player had made the at least one wager on the specific winning hand that was achieved.

In accordance with another embodiment of the present invention, a video poker-style game is disclosed. The game comprises, in combination: means for displaying an initial hand of playing cards for the video poker-style game; means for displaying a payout table associated with probabilities of obtaining at least one selected winning hand of the game depending only upon the specific playing cards dealt in the initial hand; means for permitting the player to make the at least one wager on obtaining at least one selected winning hand of the game depending only upon the specific playing cards dealt in the initial hand; means for displaying the payout associated with each the at least one wager; means for permitting the player to hold a desired number of cards from the initial hand; means for permitting the player to receive a replacement card for each of the cards that the player elects not to hold; means for determining if a winning hand has been achieved in the game; and means for paying the player in accordance with the payout table in the event that a winning hand is achieved and the player had made the at least one wager on the specific winning hand that was achieved.

In accordance with another embodiment of the present invention, a video poker-style game is disclosed. The game comprises, in combination: means for displaying an initial hand of playing cards for the video poker-style game; means for permitting the player to hold a desired number of cards from the initial hand; means for displaying a payout table associated with probabilities of obtaining at least one selected winning hand of the game depending only upon the specific playing cards held from the initial hand; means for permitting the player to make the at least one wager on obtaining at least one selected winning hand of the game depending only upon the specific playing cards held from the initial hand; means for displaying the payout associated with each the at least one wager; means for permitting the player to receive a replacement card for each of the cards that the player elects not to hold; means for determining if a winning hand has been achieved in the game; and means for paying the player in accordance with the payout table in the event that a winning hand is achieved and the player had made the at least one wager on the specific winning hand that was achieved.

In accordance with another embodiment of the present invention, a video poker-style game is disclosed. The game comprises, in combination: means for displaying an initial payout table associated with probabilities of obtaining at least one selected winning hand of the game; means for permitting the player to make at least one initial wager on obtaining at least one selected winning hand of the game; means for displaying the payout associated with each the at least one initial wager; means for displaying an initial hand of playing cards for the poker-style game; means for displaying a secondary payout table associated with probabilities of obtaining at least one selected winning hand of the game depending only upon the specific playing cards dealt in the initial hand; means for permitting the player to make at least one secondary wager on obtaining at least one selected winning hand of the game depending only upon the specific playing cards dealt in the initial hand; means for displaying the payout associated with each the at least one secondary wager; means for permitting the player to hold a desired number of cards from the initial hand; means for permitting the player to receive a replacement card for each of the cards that the player elects not to hold; means for determining if a winning hand has been achieved in the game; means for paying the player in accordance with the initial payout table in the event that a winning hand is achieved and the player had made the at least one initial wager on the specific winning hand that was achieved; and means for paying the player in accordance with the secondary payout table in the event that a winning hand is achieved and the player had made the at least one secondary wager on the specific winning hand that was achieved.

In accordance with another embodiment of the present invention, a video poker-style game is disclosed. The game comprises, in combination: means for displaying an initial payout table associated with probabilities of obtaining at least one selected winning hand of the game; means for permitting the player to make at least one initial wager on obtaining at least one selected winning hand of the game; means for displaying the payout associated with each the at least one initial wager; means for displaying an initial hand of playing cards for the poker-style game; means for permitting the player to hold a desired number of cards from the initial hand; means for displaying a secondary payout table associated with probabilities of obtaining at least one selected winning hand of the game depending only upon the specific playing cards held from the initial hand; means for permitting the player to make at least one secondary wager on obtaining at least one selected winning hand of the game depending only upon the specific playing cards held from the initial hand; means for displaying the payout associated with each the at least one secondary wager; means for permitting the player to receive a replacement card for each of the cards that the player elects not to hold; means for determining if a winning hand has been achieved in the game; means for paying the player in accordance with the initial payout table in the event that a winning hand is achieved and the player had made the at least one initial wager on the specific winning hand that was achieved; and means for paying the player in accordance with the secondary payout table in the event that a winning hand is achieved and the player had made the at least one secondary wager on the specific winning hand that was achieved.

In accordance with another embodiment of the present invention, a method for playing a video poker-style game is disclosed. The method comprises, in combination: providing a video display adapted to display to a player a poker-style game; and permitting the player to make at least one wager to obtain on the video display at least one certain selected winning hand.

In accordance with another embodiment of the present invention, a method for playing a video poker-style game is disclosed. The method comprises, in combination: displaying a payout table associated with probabilities of obtaining at least one selected winning hand of the game; permitting the player to make the at least one wager on obtaining at least one selected winning hand of the game; displaying the payout associated with each the at least one wager; displaying an initial hand of playing cards for the video poker-style game; permitting the player to hold a desired number of the cards from the initial hand; permitting the player to receive a replacement card for each of the cards that the player elects not to hold; determining if a winning hand has been achieved in the game; and paying the player in accordance with the payout table in the event that a winning hand is achieved and the player had made the at least one wager on the specific winning hand that was achieved.

In accordance with another embodiment of the present invention, a method for playing a video poker-style game is disclosed. The method comprises, in combination displaying a payout table associated with probabilities of obtaining at least one selected winning hand of the game; providing the player with an option to make the at least one wager on obtaining a certain selected winning hand of the game; displaying the payouts associated with each the at least one wager; displaying a hand of playing cards for the video poker-style game; determining if a winning hand has been achieved in the game; and paying the player in accordance with the payout table in the event that a winning hand is achieved and the player had made the at least one wager on the specific winning hand that was achieved.

In accordance with another embodiment of the present invention, a method for playing a video poker-style game is disclosed. The method comprises the steps of: displaying an initial hand of playing cards for the video poker-style game; displaying a payout table associated with probabilities of obtaining at least one selected winning hand of the game depending only upon the specific playing cards dealt in the initial hand; permitting the player to make the at least one wager on obtaining at least one selected winning hand of the game depending only upon the specific playing cards dealt in the initial hand; displaying the payout associated with each the at least one wager; permitting the player to hold a desired number of cards from the initial hand; permitting the player to receive a replacement card for each of the cards that the player elects not to hold; determining if a winning hand has been achieved in the game; and paying the player in accordance with the payout table in the event that a winning hand is achieved and the player had made the at least one wager on the specific winning hand that was achieved.

In accordance with another embodiment of the present invention, a method for playing a video poker-style game is disclosed. The method comprises the steps of: displaying an initial hand of playing cards for the video poker-style game; permitting the player to hold a desired number of cards from the initial hand; displaying a payout table associated with probabilities of obtaining at least one selected winning hand of the game depending only upon the specific playing cards held from the initial hand; permitting the player to make the at least one wager on obtaining at least one selected winning hand of the game depending only upon the specific playing cards held from the initial hand; displaying the payout associated with each the at least one wager; permitting the player to receive a replacement card for each of the cards that the player elects not to hold; determining if a winning hand has been achieved in the game; and paying the player in accordance with the payout table in the event that a winning hand is achieved and the player had made the at least one wager on the specific winning hand that was achieved.

In accordance with another embodiment of the present invention, a method for playing a video poker-style game is disclosed. The method comprises the steps of: displaying an initial payout table associated with probabilities of obtaining at least one selected winning hand of the game; permitting the player to make at least one initial wager on obtaining at least one selected winning hand of the game; displaying the payout associated with each the at least one initial wager; displaying an initial hand of playing cards for the poker-style game; displaying a secondary payout table associated with probabilities of obtaining at least one selected winning hand of the game depending only upon the specific playing cards dealt in the initial hand; permitting the player to make at least one secondary wager on obtaining at least one selected winning hand of the game depending only upon the specific playing cards dealt in the initial hand; displaying the payout associated with each the at least one secondary wager; permitting the player to hold a desired number of cards from the initial hand; permitting the player to receive a replacement card for each of the cards that the player elects not to hold; determining if a winning hand has been achieved in the game; paying the player in accordance with the initial payout table in the event that a winning hand is achieved and the player had made the at least one initial wager on the specific winning hand that was achieved; and paying the player in accordance with the secondary payout table in the event that a winning hand is achieved and the player had made the at least one secondary wager on the specific winning hand that was achieved.

In accordance with another embodiment of the present invention, a method for playing a video poker-style game is disclosed. The method comprises the steps of: displaying an initial payout table associated with probabilities of obtaining at least one selected winning hand of the game; permitting the player to make at least one initial wager on obtaining at least one selected winning hand of the game; displaying the payout associated with each the at least one initial wager; displaying an initial hand of playing cards for the poker-style game; permitting the player to hold a desired number of cards from the initial hand; displaying a secondary payout table associated with probabilities of obtaining at least one selected winning hand of the game depending only upon the specific playing cards held from the initial hand; permitting the player to make at least one secondary wager on obtaining at least one selected winning hand of the game depending only upon the specific playing cards held from the initial hand; displaying the payout associated with each the at least one secondary wager; permitting the player to receive a replacement card for each of the cards that the player elects not to hold; determining if a winning hand has been achieved in the game; paying the player in accordance with the initial payout table in the event that a winning hand is achieved and the player had made the at least one initial wager on the specific winning hand that was achieved; and paying the player in accordance with the secondary payout table in the event that a winning hand is achieved and the player had made the at least one secondary wager on the specific winning hand that was achieved.

### BRIEF DESCRIPTION OF THE DRAWINGS

FIG. 1 is a front elevational view of a video poker machine or terminal in accordance with the invention.

FIG. 2 is a flow chart depicting a number of methods of play consistent with the present invention.

FIG. 3 is a flow chart depicting a number of further methods of play consistent with the present invention.

FIG. 4 is a flow chart depicting a number of still further methods of play consistent with the present invention.

FIG. 5 is a flow chart depicting a number of additional methods of play consistent with the present invention.

FIG. 6 is a flow chart depicting a number of further methods of play consistent with the present invention.

FIG. 7 is a flow chart depicting a number of still further methods of play consistent with the present invention.

### DETAILED DESCRIPTION OF THE PREFERRED EMBODIMENTS

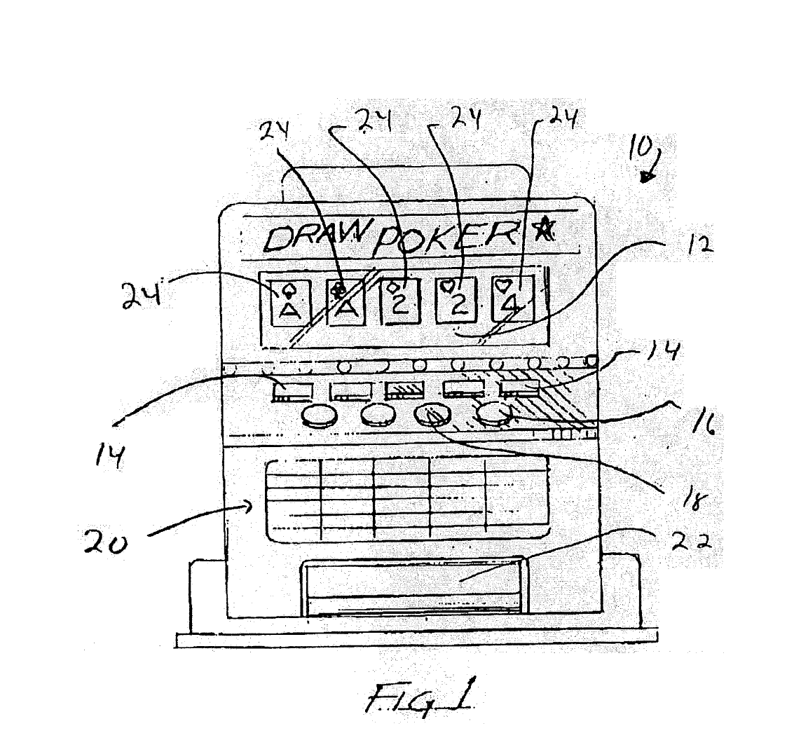

Referring first to FIG. 1, a video poker machine terminal 10 is shown. Its main features include a video display 12, five hold buttons 14, a draw/deal button 16, at least one bet button 18, a pay table 20, and a coin output 22. The terminal 10 should also have a payment receiver (not shown), through which coins, cash, payment cards, paper credits or the like may be inserted for purposes of placing a wager.

Generally, in a prior art video poker game, play is initiated by the insertion of a payment into the payment receiver. A player will typically then depress the bet button 18 in order to receive a display of a hand of cards. (In some games, more than one bet button 18 is provided, with, for example, one bet button allowing a player to bet one amount, and another allowing a player to bet a larger or additional amount.) After a hand of cards is displayed in the video display 12, the player then decides which he or she wants to hold and which to discard. A player indicates a hold selection for each card that is to be held by depressing the hold button 14 located directly below a card 24 that is to be held. (If a player changes his or her mind, the hold button 14 can be depressed a second time to cancel the selection.)

Once the player completes his or her hold selections, the player will depress the draw/deal button 16 a second time. This will cause the non-held cards 24 to be replaced with new cards. If the player has a winning hand according to the pay table 20, a payment is made and can either be paid through the coin output 22 or simply indicated on a portion of the video display 12 as credits to be paid later.

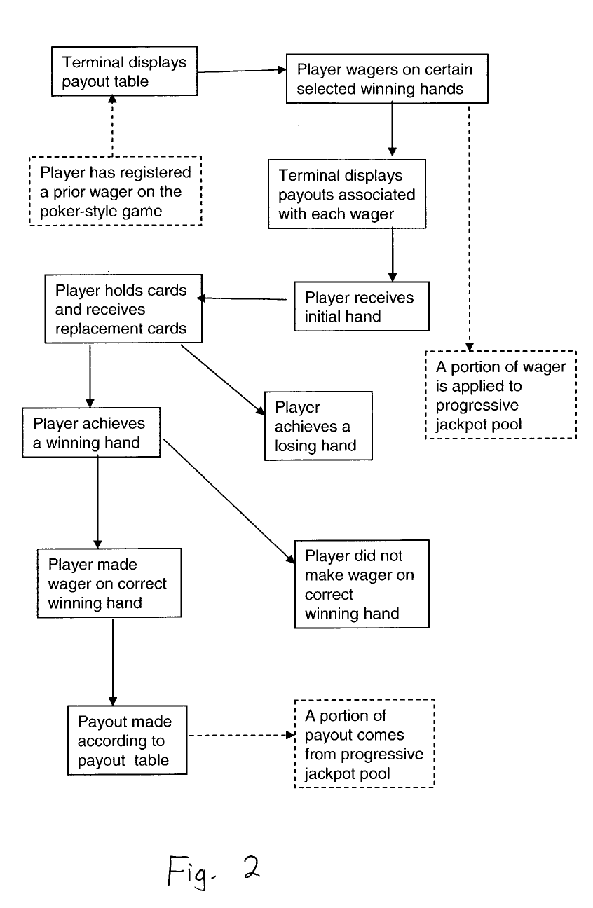

The present invention concerns both the video poker-style game using, for example, the video poker machine on terminal 10 of FIG. 1, and the wagering options provided to the player both before play is initiated and during the game. Referring to FIG. 2, a method of playing and wagering options of one embodiment of the game of the present invention is illustrated. The video display 12 will display a pay table which relates the payouts (as a ratio of the amount paid per unit bet) associated with wagers placed on certain selected winning hands. The following table shows a preferred pay table to be used with one embodiment of the game and method of the present invention. Changes in the various ratios can be made, as desired, in keeping with the concepts of this invention.

TABLE 1

| | |
|---|---|
| Royal Flush | 20,000 to 1 |
| Straight Flush | 5,000 to 1 |
| Four of a Kind | 300 to 1 |
| Full House | 60 to 1 |
| Flush | 60 to 1 |
| Straight | 60 to 1 |
| Three of a Kind | 8 to 1 |
| Two Pair | 3 to 1 |
| Jacks or Better | 2 to 1 |

The player will then wager on the certain selected winning hand or hands of his or her choice. This can be done in any desired form, including for example having a touch-sensitive region on, for example, the video display 12, or on the pay table 20 so that the player can touch the different section or sections of the pay table 20 to select the winning hand or hands on which he or she chooses to wager, as well as selecting how much to wager on each selected hand. Software in the terminal 10 is used to recognize that such wagers have been made and the amount of any payout due to the player depending on the amount wagered. As the player makes these wagers, for example, the video display 12 or the pay table 20 will display the potential payouts associated with each wager should the player obtain or achieve that certain selected winning hand. Play will then continue as described above in prior art games with the player receiving a hand of cards, deciding which cards to hold, and receiving replacements for the non-held cards. After play is completed, software in the terminal 10 will determine if a winning hand has been achieved (i.e. a pair of Jacks or better) and also if a wager was registered on the player obtaining the certain selected winning hand or hands that occurred. If such a wager was registered, a payment is made according to the payout odds in Table 1, or according to other pre-set payout odds acceptable to the casino and any applicable gaming authority.

Still referring to FIG. 2, a method of play of another embodiment of the game of the present invention is illustrated. There is a concern that some casino operators might not want to provide the wagering option of the present invention unless the player has also wagered in the traditional manner of prior art games as described above. To address this, optionally, a player can be required to register such a traditional wager prior to receiving the wagering option of the present invention (to pre-select a winning hand or hands). That this step is optional is illustrated by dashed-lines for this portion of the flow chart of FIG. 2.

As an additional option, also illustrated by dashed lines, a portion of the amount wagered can be applied to a progressive jackpot pool, and a portion of the payout for successfully obtaining a pre-selected winning hand or hands can come from this progressive jackpot pool. This would have the effect of increasing the potential payouts associated with the above described wagers, thereby increasing player excitement.

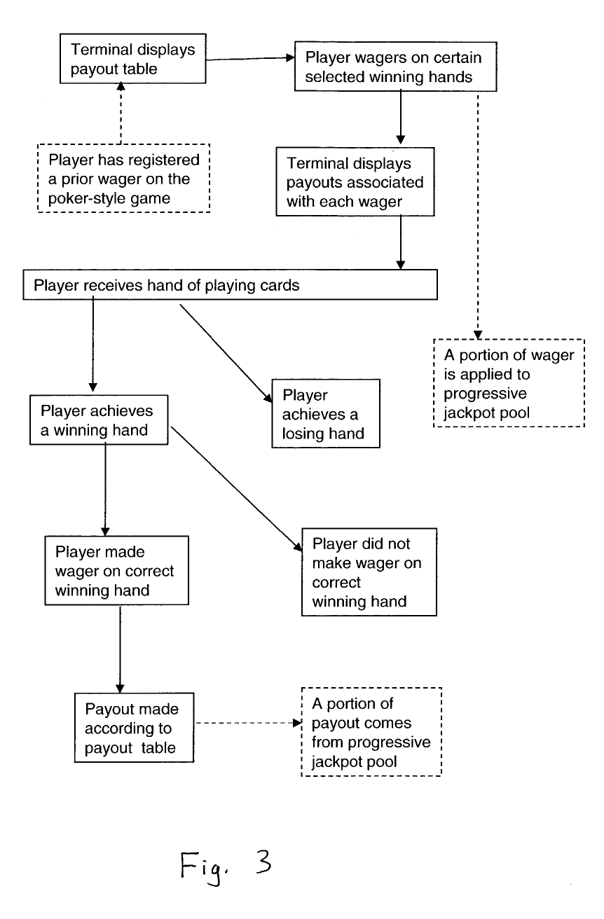

Referring to FIG. 3, another method of an embodiment of the game of the present invention is illustrated. In this embodiment, the video display 12, or, if desired, the display shown in the pay table 20 will display a pay table which relates the payouts associated with wagers placed on certain selected winning hands. The following table shows a preferred pay table to be used with the present embodiment of the game and method of the present invention. Variations in the ratios shown in this Table 2 can be made, as desired, at the option of the casinos and/or the applicable gaming authority.

TABLE 2

| | |
|---|---|
| Royal Flush | 500,000 to 1 |
| Straight Flush | 60,000 to 1 |
| Four of a Kind | 3000 to 1 |
| Full House | 600 to 1 |
| Flush | 400 to 1 |
| Straight | 200 to 1 |
| Three of a Kind | 40 to 1 |
| Two Pair | 15 to 1 |
| Jacks or Better | 5 to 1 |

The player will then pre-wager on the certain selected winning hand or hands of his or her choice in the manner described above. Software in the terminal 10 will recognize that such wagers have been made. As the player makes these wagers, the video display 12, or the pay table 20 will display the potential payouts associated with each wager should the player achieve that certain selected winning hand. The video display 12 will then display a hand of playing cards. Software in the terminal 10 will determine if a winning hand has been achieved and if a wager was pre-registered on obtaining the certain selected winning hand or hands that occurred. If such a wager was so registered, a payment is made according to the payout odds in Table 2.

As with the first embodiment, there is an option, also illustrated by dashed lines in FIG. 3, to require the player to register a traditional wager prior to receiving the wagering option of the present invention.

As with the first embodiment, there is another option also illustrated by dashed lines in FIG. 3, that a portion of the amount wagered can be applied to a progressive jackpot pool, and a portion of the payout can come from this progressive jackpot pool.

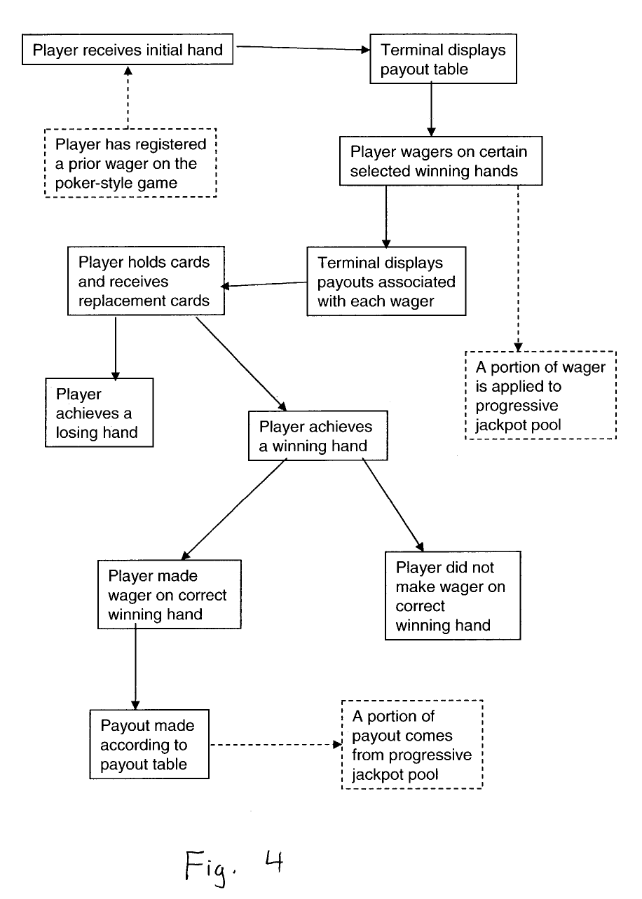

Referring to FIG. 4, another method of an embodiment of the game of the present invention is illustrated. In this embodiment, a player receives an initial hand of playing cards. Once this hand is displayed, the video display 12 or pay table 20 will display a payout table which relates the payouts associated with wagers placed on obtaining a certain selected winning hand or hands depending on the combination of cards dealt in the initial hand. Because the possible card combinations in an initial poker hand are numerous, software in the terminal 10 must store a plurality of possible payout tables. The software will then recognize what combination of cards has been dealt and display the appropriate pay table. The following table shows a possible pay table to be used with the present embodiment of the game and method of the present invention. Variations in the ratios shown in this Table 3 can be made, as desired, at the option of the casinos and/or the applicable gaming authority.

TABLE 3

| | |
|---|---|
| Royal Flush | 10,000 to 1 |
| Straight Flush | 2,000 to 1 |
| Four of a Kind | 200 to 1 |
| Full House | 60 to 1 |
| Flush | 25 to 1 |
| Straight | 80 to 1 |
| Three of a Kind | 6 to 1 |
| Two Pair | 2 to 1 |
| Jacks or Better | 1 to 1 |

The player can then register wagers on obtaining a certain selected winning hand or hands in the manner described above. Play will then continue as described above in prior art games with the player deciding which cards to hold and receiving replacements for the non-held cards. After play is completed, software in the terminal 10 will determine if a winning hand (or hands) has been achieved and if a wager was pre-registered on obtaining the certain selected winning hand or hands that occurred. If such a wager was so registered, a payment is made according to the payout odds in Table 3, or according to any acceptable variation of those odds shown in Table 3.

As with the previous embodiments, there is an option, also illustrated by dashed lines in FIG. 4, to require the player to pre-register a traditional wager prior to receiving the wagering option of this embodiment of the present invention.

As with the previous embodiments, there is another option also illustrated by dashed lines in FIG. 4, that a portion of the amount wagered can be applied to a progressive jackpot pool, and a portion of the payout can come from this progressive jackpot pool.

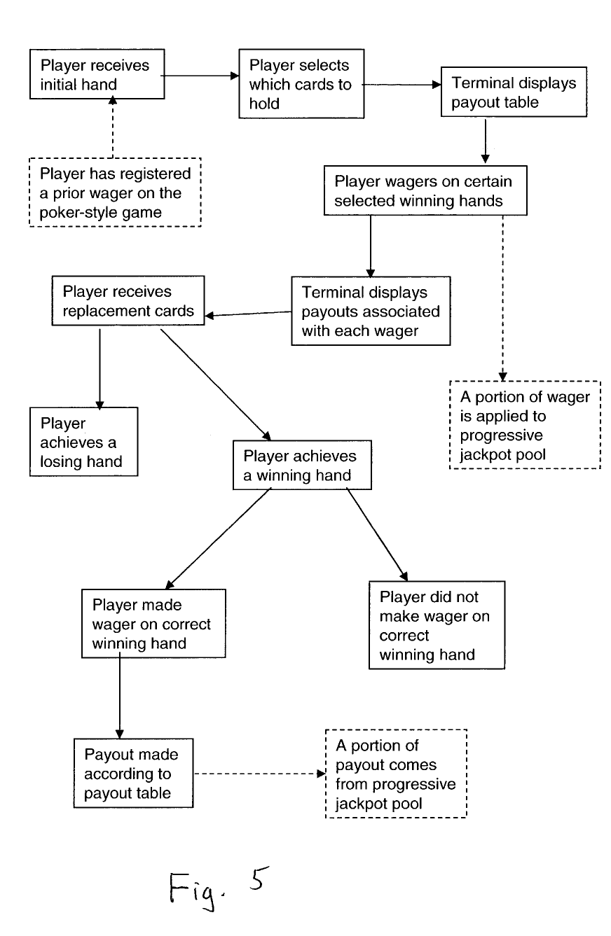

Referring now to FIG. 5, another method of an embodiment of the game of the present invention is illustrated. In this embodiment, a player receives an initial hand of playing cards. The player will then decide which cards to hold. Once the desired cards have been held, the video display 12 or pay table 20 will display a payout table which relates the payouts associated with wagers placed on obtaining a certain selected winning hand or hands depending on the combination of cards held from the initial hand. Because the possible combinations of cards held from an initial poker hand are numerous, software in the terminal 10 must store a plurality of possible payout tables. The software will then recognize what combination of cards has been held and display the appropriate pay table. Table 3 shows a possible pay table to be used with the present embodiment of the game and method of the present invention. The player can then register wagers on certain selected winning hands in the manner described above. Play will then continue as described above in prior art games with the player receiving replacements for the non-held cards. After play is completed, software in the terminal 10 will determine if a winning hand has been achieved and if a wager was registered on the certain selected winning hand or hands that occurred. If such a wager was so registered, a payment is made according to, for example, the payout odds in Table 3.

As with the previous embodiments, there is an option, also illustrated by dashed lines, to require the player to register a traditional wager prior to receiving the wagering option of the present invention.

As with the previous embodiments, there is another option also illustrated by dashed lines, that a portion of the amount wagered can be applied to a progressive jackpot pool, and a portion of the payout can come from this progressive jackpot pool.

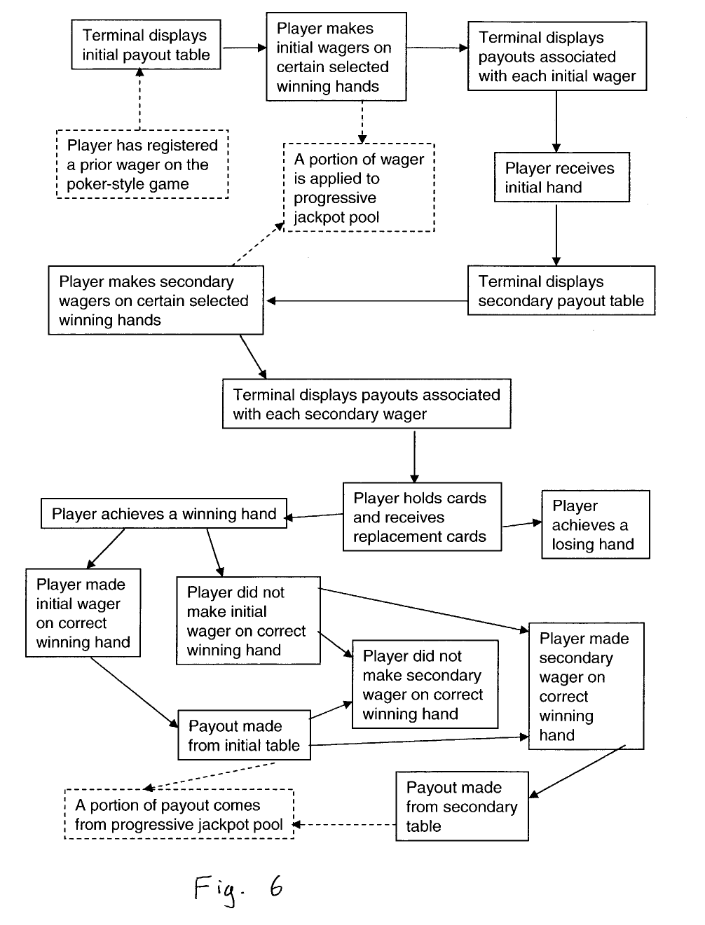

Referring now to FIG. 6, another method of an embodiment of the game of the present invention is illustrated. In this embodiment, the video display 12 or pay table 20 will display an initial pay table which relates the payouts associated with wagers placed on certain selected winning hand or hands (see Table 1). The player will then make initial wagers on obtaining the certain selected winning hand or hands of his or her choice. This can be done in the manner described above. Software in the terminal 10 will recognize that such wagers have been made. As the player makes these wagers, the video display 12 or pay table 20 will display the potential payouts associated with each wager should the player achieve that certain selected winning hand or hands. The video display 12 will then display an initial hand of playing cards. Software in the terminal 10 will recognize what combination of cards has been dealt and display an appropriate secondary pay table relating the payouts associated with wagers placed on obtaining a certain selected winning hand or hands (see Table 3). The player can then register secondary wagers on obtaining a certain selected winning and or hands in the manner described above. Play will then continue as described above in prior art games with the player deciding which cards to hold and receiving replacements for the non-held cards. After play is completed, software in the terminal 10 will determine if a winning hand (or hands) has been achieved and if an initial wager was pre-registered on obtaining the certain selected winning hand or hands that occurred. If such a wager was so registered, a payment is made according to the payout odds in Table 1. The software will then determine if a secondary wager was registered on obtaining the certain selected winning hand or hands that occurred. If such a wager was registered, a payment will be made according to, for example, the payout odds in Table 3.

As with the previous embodiments, there is an option, also illustrated by dashed lines in FIG. 6, to require the player to pre-register a traditional wager prior to receiving the two separate wagering options of this embodiment of the present invention.

As with the previous embodiments, there is another option also illustrated by dashed lines in FIG. 6, that a portion of the amount wagered in both the initial wagers and secondary wagers can be applied to a progressive jackpot pool, and a portion of the payout can come from this progressive jackpot pool.

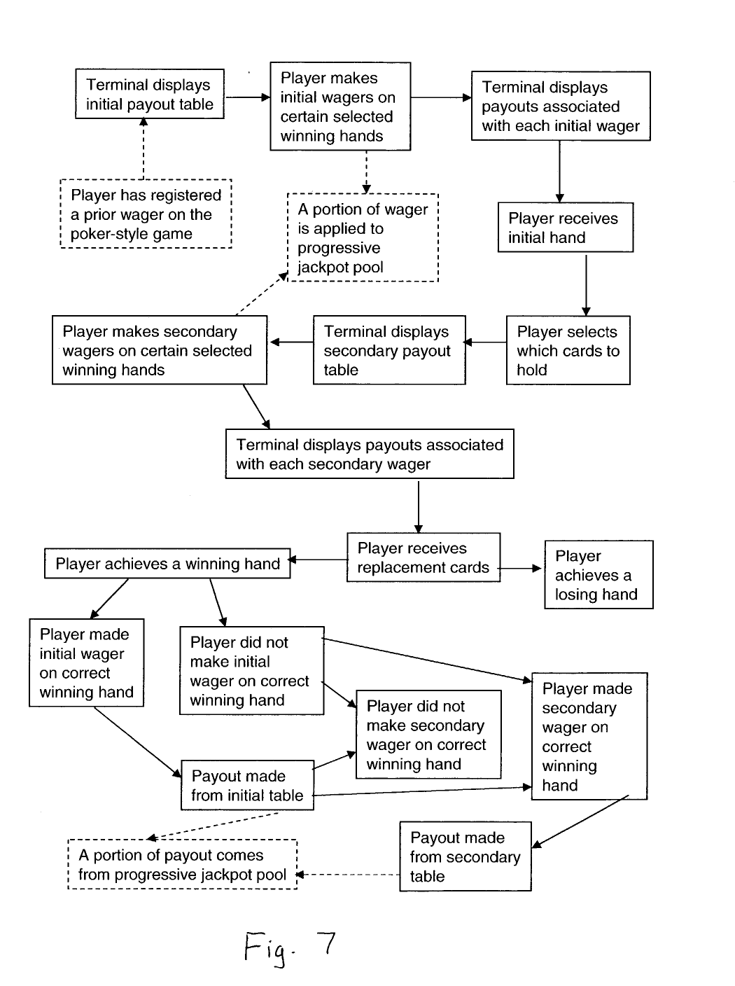

Referring now to FIG. 7, another method of an embodiment of the game of the present invention is illustrated. In this embodiment, the video display 12 or pay table 20 will display an initial pay table which relates the payouts associated with wagers placed on obtaining a certain selected winning hand or hands (see Table 1). The player will then make an initial wager or wagers on obtaining the certain selected winning hands of his or her choice. This can be done in the manner described above. Software in the terminal 10 will recognize that such wagers have been made. As the player makes these wagers, the video display 12 or pay table 20 will display the potential payouts associated with each wager should the player achieve that certain selected winning hand or hands. The video display 12 will then display an initial hand of playing cards. The player will then decide which cards to hold. Software in the terminal 10 will recognize what combination of cards has been held and display an appropriate secondary pay table relating the payouts associated with wagers placed on obtaining a certain selected winning hand or hands (see Table 3). The player can then register secondary wagers on obtaining a certain selected winning hand or hands in the manner described above. Play will then continue as described above in prior art games with the player receiving replacements for the non-held cards. After play is completed, software in the terminal 10 will determine if a winning hand (or hands) has been achieved and if an initial wager was pre-registered on obtaining the certain selected winning hand or hands that occurred. If such a wager was so registered, a payment is made according to the payout odds in Table 1. The software will then determine if a secondary wager was registered on obtaining the certain selected winning hand or hands that occurred. If such a second wager was so registered, a payment will be made according to, for example, the payout odds in Table 3.

As with the previous embodiments, there is an option, also illustrated by dashed lines in FIG. 7, to require the player to pre-register a traditional wager prior to receiving the wagering options of the present invention.

As with the previous embodiments, there is another option also illustrated by dashed lines in FIG. 7, that a portion of the amount wagered in both the initial wagers and secondary wagers can be applied to a progressive jackpot pool, and a portion of the payout can come from this progressive jackpot pool.

While the invention has been illustrated with respect to several specific embodiments thereof, these embodiments should be considered as illustrative rather than limiting. Various modifications and additions may be made and will be apparent to those skilled in the art. Accordingly, the invention should not be limited by the foregoing description, but rather should be defined only by the following claims.

We claim:

1. A video poker-style game comprising:
a video display adapted to display to a player a poker-style game; and
means for permitting said player to make at least one wager to obtain on said video display at least one certain selected winning hand.

2. The video poker-style game of claim 1 further comprising:
means for displaying a payout table associated with probabilities of obtaining at least one selected winning hand of said game;
means for permitting said player to make said at least one wager on obtaining at least one selected winning hand of said game;
means for displaying the payout associated with each said at least one wager;
means for displaying an initial hand of playing cards for said video poker-style game;
means for permitting said player to hold a desired number of said cards from said initial hand;
means for permitting said player to receive a replacement card for each of said cards that said player elects not to hold;
means for determining if a winning hand has been achieved in said game; and
means for paying said player in accordance with said payout table in the event that a winning hand is achieved and said player had made said at least one wager on the specific winning hand that was achieved.

3. The video poker-style game of claim 2 wherein a portion of said payout is a progressive payout amount.

4. The video poker-style game of claim 2 wherein said player is only permitted to make said at least one wager when said player had also made a wager on obtaining any non-selected winning hand.

5. The video poker-style game of claim 1 further comprising:
means for displaying a payout table associated with probabilities of obtaining at least one selected winning hand of said game;
means for providing said player with an option to make said at least one wager on obtaining a certain selected winning hand of said game;
means for displaying the payouts associated with each said at least one wager;
means for displaying a hand of playing cards for said video poker-style game;
means for determining if a winning hand has been achieved in said game; and
means for paying said player in accordance with said payout table in the event that a winning hand is achieved and said player had made said at least one wager on the specific winning hand that was achieved.

6. The video poker-style game of claim 5 wherein a portion of said payout is a progressive payout amount.

7. The video poker-style game of claim 5 wherein said player is only permitted to make said at least one wager when said player had also made a wager on obtaining any non-selected winning hand.

8. The video poker-style game of claim 1 further comprising:
means for displaying an initial hand of playing cards for said video poker-style game;
means for displaying a payout table associated with probabilities of obtaining at least one selected winning hand of said game depending only upon the specific playing cards dealt in said initial hand;
means for permitting said player to make said at least one wager on obtaining at least one selected winning hand of said game depending only upon the specific playing cards dealt in said initial hand;
means for displaying the payout associated with each said at least one wager;
means for permitting said player to hold a desired number of cards from said initial hand;
means for permitting said player to receive a replacement card for each of said cards that said player elects not to hold;
means for determining if a winning hand has been achieved in said game; and
means for paying said player in accordance with said payout table in the event that a winning hand is achieved and said player had made said at least one wager on the specific winning hand that was achieved.

9. The video poker-style game of claim 8 wherein a portion of said payout is a progressive payout amount.

10. The video poker-style game of claim 8 wherein said player is only permitted to make said at least one wager when said player had also made a wager on obtaining any non-selected winning hand.

11. The video poker-style game of claim 1 further comprising:
means for displaying an initial hand of playing cards for said video poker-style game;
means for permitting said player to hold a desired number of cards from said initial hand;
means for displaying a payout table associated with probabilities of obtaining at least one selected winning hand of said game depending only upon the specific playing cards held from said initial hand;
means for permitting said player to make said at least one wager on obtaining at least one selected winning hand of said game depending only upon the specific playing cards held from said initial hand;
means for displaying the payout associated with each said at least one wager;
means for permitting said player to receive a replacement card for each of said cards that said player elects not to hold;
means for determining if a winning hand has been achieved in said game; and
means for paying said player in accordance with said payout table in the event that a winning hand is achieved and said player had made said at least one wager on the specific winning hand that was achieved.

12. The video poker-style game of claim 11 wherein a portion of said payout is a progressive payout amount.

13. The video poker-style game of claim 11 wherein said player is only permitted to make said at least one wager when said player had also made a wager on obtaining any non-selected winning hand.

14. The video poker-style game of claim 1 further comprising:
means for displaying an initial payout table associated with probabilities of obtaining at least one selected winning hand of said game;
means for permitting said player to make at least one initial wager on obtaining at least one selected winning hand of said game;
means for displaying the payout associated with each said at least one initial wager;
means for displaying an initial hand of playing cards for said poker-style game;
means for displaying a secondary payout table associated with probabilities of obtaining at least one selected winning hand of said game depending only upon the specific playing cards dealt in said initial hand;
means for permitting said player to make at least one secondary wager on obtaining at least one selected winning hand of said game depending only upon the specific playing cards dealt in said initial hand;
means for displaying the payout associated with each said at least one secondary wager;
means for permitting said player to hold a desired number of cards from said initial hand;
means for permitting said player to receive a replacement card for each of said cards that said player elects not to hold;
means for determining if a winning hand has been achieved in said game;
means for paying said player in accordance with said initial payout table in the event that a winning hand is achieved and said player had made said at least one initial wager on the specific winning hand that was achieved; and
means for paying said player in accordance with said secondary payout table in the event that a winning hand is achieved and said player had made said at least one secondary wager on the specific winning hand that was achieved.

15. The video poker-style game of claim 14 wherein a portion of said initial payout is a progressive payout amount.

16. The video poker-style game of claim 14 wherein a portion of said secondary payout is a progressive payout amount.

17. The video poker-style game of claim 14 wherein said player is only permitted to make said at least one initial wager when said player had also made a wager on obtaining any non-selected winning hand.

18. The video poker-style game of claim 14 wherein said player is only permitted to make said at least one secondary wager when said player had also made a wager on obtaining any non-selected winning hand.

19. The video poker-style game of claim 1 further comprising:
means for displaying an initial payout table associated with probabilities of obtaining at least one selected winning hand of said game;
means for permitting said player to make at least one initial wager on obtaining at least one selected winning hand of said game;
means for displaying the payout associated with each said at least one initial wager;
means for displaying an initial hand of playing cards for said poker-style game;
means for permitting said player to hold a desired number of cards from said initial hand;
means for displaying a secondary payout table associated with probabilities of obtaining at least one selected winning hand of said game depending only upon the specific playing cards held from said initial hand;
means for permitting said player to make at least one secondary wager on obtaining at least one selected winning hand of said game depending only upon the specific playing cards held from said initial hand;
means for displaying the payout associated with each said at least one secondary wager;
means for permitting said player to receive a replacement card for each of said cards that said player elects not to hold;
means for determining if a winning hand has been achieved in said game;
means for paying said player in accordance with said initial payout table in the event that a winning hand is achieved and said player had made said at least one initial wager on the specific winning hand that was achieved; and
means for paying said player in accordance with said secondary payout table in the event that a winning hand is achieved and said player had made said at least one secondary wager on the specific winning hand that was achieved.

20. The video poker-style game of claim 19 wherein a portion of said initial payout is a progressive payout amount.

21. The video poker-style game of claim 19 wherein a portion of said secondary payout is a progressive payout amount.

22. The video poker-style game of claim 19 wherein said player is only permitted to make said at least one initial wager when said player had also made a wager on obtaining any non-selected winning hand.

23. The video poker-style game of claim 19 wherein said player is only permitted to make said at least one secondary wager when said player had also made a wager on obtaining any non-selected winning hand.

24. A method for playing a poker-style game comprising the steps of:
providing a video display adapted to display to a player a poker-style game; and
permitting said player to make at least one wager to obtain on said video display at least one certain selected winning hand.

25. The method of claim 24 further comprising the steps of:
displaying a payout table associated with probabilities of obtaining at least one selected winning hand of said game;
permitting said player to make said at least one wager on obtaining at least one selected winning hand of said game;
displaying the payout associated with each said at least one wager;
displaying an initial hand of playing cards for said video poker-style game;
permitting said player to hold a desired number of said cards from said initial hand;
permitting said player to receive a replacement card for each of said cards that said player elects not to hold;
determining if a winning hand has been achieved in said game; and
paying said player in accordance with said payout table in the event that a winning hand is achieved and said player had made said at least one wager on the specific winning hand that was achieved.

26. The method of claim 25 wherein a portion of said payout is a progressive payout amount.

27. The method of claim 25 wherein said player is only permitted to make said at least one wager when said player had also made a wager on obtaining any non-selected winning hand.

28. The method of claim 24 further comprising the steps of:
displaying a payout table associated with probabilities of obtaining at least one selected winning hand of said game;
providing said player with an option to make said at least one wager on obtaining a certain selected winning hand of said game;
displaying the payouts associated with each said at least one wager;
displaying a hand of playing cards for said video poker-style game;
determining if a winning hand has been achieved in said game; and
paying said player in accordance with said payout table in the event that a winning hand is achieved and said player had made said at least one wager on the specific winning hand that was achieved.

29. The method of claim 28 wherein a portion of said payout is a progressive payout amount.

30. The method of claim 28 wherein said player is only permitted to make said at least one wager when said player had also made a wager on obtaining any non-selected winning hand.

31. The method of claim 24 further comprising the steps of:
displaying an initial hand of playing cards for said video poker-style game;
displaying a payout table associated with probabilities of obtaining at least one selected winning hand of said game depending only upon the specific playing cards dealt in said initial hand;
permitting said player to make said at least one wager on obtaining at least one selected winning hand of said game depending only upon the specific playing cards dealt in said initial hand;
displaying the payout associated with each said at least one wager;
permitting said player to hold a desired number of cards from said initial hand;
permitting said player to receive a replacement card for each of said cards that said player elects not to hold;
determining if a winning hand has been achieved in said game; and
paying said player in accordance with said payout table in the event that a winning hand is achieved and said player had made said at least one wager on the specific winning hand that was achieved.

32. The method of claim 31 wherein a portion of said payout is a progressive payout amount.

33. The method of claim 31 wherein said player is only permitted to make said at least one wager when said player had also made a wager on obtaining any non-selected winning hand.

34. The method of claim 24 further comprising the steps of:
displaying an initial hand of playing cards for said video poker-style game;
permitting said player to hold a desired number of cards from said initial hand;
displaying a payout table associated with probabilities of obtaining at least one selected winning hand of said game depending only upon the specific playing cards held from said initial hand;
permitting said player to make said at least one wager on obtaining at least one selected winning hand of said game depending only upon the specific playing cards held from said initial hand;
displaying the payout associated with each said at least one wager;
permitting said player to receive a replacement card for each of said cards that said player elects not to hold;
determining if a winning hand has been achieved in said game; and
paying said player in accordance with said payout table in the event that a winning hand is achieved and said player had made said at least one wager on the specific winning hand that was achieved.

35. The method of claim 34 wherein a portion of said payout is a progressive payout amount.

36. The method of claim 34 wherein said player is only permitted to make said at least one wager when said player had also made a wager on obtaining any non-selected winning hand.

37. The method of claim 24 further comprising the steps of:
displaying an initial payout table associated with probabilities of obtaining at least one selected winning hand of said game;
permitting said player to make at least one initial wager on obtaining at least one selected winning hand of said game;
displaying the payout associated with each said at least one initial wager;
displaying an initial hand of playing cards for said poker-style game;
displaying a secondary payout table associated with probabilities of obtaining at least one selected winning hand of said game depending only upon the specific playing cards dealt in said initial hand;
permitting said player to make at least one secondary wager on obtaining at least one selected winning hand of said game depending only upon the specific playing cards dealt in said initial hand;
displaying the payout associated with each said at least one secondary wager;
permitting said player to hold a desired number of cards from said initial hand;
permitting said player to receive a replacement card for each of said cards that said player elects not to hold;
determining if a winning hand has been achieved in said game;
paying said player in accordance with said initial payout table in the event that a winning hand is achieved and said player had made said at least one initial wager on the specific winning hand that was achieved; and
paying said player in accordance with said secondary payout table in the event that a winning hand is achieved and said player had made said at least one secondary wager on the specific winning hand that was achieved.

38. The method of claim 37 wherein a portion of said initial payout is a progressive payout amount.

39. The method of claim 37 wherein a portion of said secondary payout is a progressive payout amount.

40. The method of claim 37 wherein said player is only permitted to make said at least one initial wager when said player had also made a wager on obtaining any non-selected winning hand.

41. The method of claim 37 wherein said player is only permitted to make said at least one secondary wager when said player had also made a wager on obtaining any non-selected winning hand.

42. The method of claim 24 further comprising the steps of:
displaying an initial payout table associated with probabilities of obtaining at least one selected winning hand of said game;
permitting said player to make at least one initial wager on obtaining at least one selected winning hand of said game;
displaying the payout associated with each said at least one initial wager;
displaying an initial hand of playing cards for said poker-style game;
permitting said player to hold a desired number of cards from said initial hand;
displaying a secondary payout table associated with probabilities of obtaining at least one selected winning hand of said game depending only upon the specific playing cards held from said initial hand;
permitting said player to make at least one secondary wager on obtaining at least one selected winning hand of said game depending only upon the specific playing cards held from said initial hand;
displaying the payout associated with each said at least one secondary wager;
permitting said player to receive a replacement card for each of said cards that said player elects not to hold;
determining if a winning hand has been achieved in said game;
paying said player in accordance with said initial payout table in the event that a winning hand is achieved and said player had made said at least one initial wager on the specific winning hand that was achieved; and
paying said player in accordance with said secondary payout table in the event that a winning hand is achieved and said player had made said at least one secondary wager on the specific winning hand that was achieved.

43. The method of claim 42 wherein a portion of said initial payout is a progressive payout amount.

44. The method of claim 42 wherein a portion of said secondary payout is a progressive payout amount.

45. The method of claim 42 wherein said player is only permitted to make said at least one initial wager when said player had also made a wager on obtaining any non-selected winning hand.

46. The method of claim 42 wherein said player is only permitted to make said at least one secondary wager when said player had also made a wager on obtaining any non-selected winning hand.
